(19) United States
(12) Patent Application Publication
(10) Pub. No.: US 2007/0260862 A1
(43) Pub. Date: Nov. 8, 2007

(54) Providing storage in a memory hierarchy for prediction information

(76) Inventor: Scott McFarling, Santa Clara, CA (US)

Correspondence Address: TROP PRUNER & HU, PC, 1616 S. VOSS ROAD, SUITE 750, HOUSTON, TX, 77057-2631, US

(21) Appl. No.: 11/416,820

(22) Filed: May 3, 2006

(51) Int. Cl. G06F 15/00

(52) U.S. Cl. 712/240

(57) ABSTRACT

In one embodiment, the present invention includes an apparatus having a prediction unit to predict a direction to be taken at a branch and a memory coupled to the prediction unit to store prediction data to be accessed by the prediction unit. In this way, great amounts of prediction data may be stored in the memory while keeping the prediction unit of relatively small size. Other embodiments are described and claimed.

### BACKGROUND

Embodiments of the present invention relate to processor-based systems and more particularly to predicting program flow in such systems.

Predicting the direction of conditional branches is one of the key bottlenecks limiting processor performance. Various techniques have been proposed and implemented to perform to such predictions. Some processors implement a sequence of prediction stages, each improving on the previous stage, and each using a different type of predictor. A tag or address generated from a branch address is used to access a counter that is used to determine whether the prediction from the current stage should replace the prediction coming from the previous stage.

The end result generated by a predictor is a prediction of the direction of the conditional branch. Based on this prediction, a processor can begin execution of the path predicted by the predictor. In this way, improved performance may be realized, as predictive or speculative execution may occur and then may be committed if the prediction proves to be correct.

One of the key limits to a predictor is that it must be kept small, so that the predictor can be able to generate new predictions rapidly to keep up with a processor pipeline. Unfortunately, this small size prevents the predictor from modeling all the branch patterns it may see. Furthermore, the small size causes frequent disruptions or evictions of data present in the predictor. These disruptions are both time consuming and prevent maintenance of prediction information that may prove valuable during program execution.

### BRIEF DESCRIPTION OF THE DRAWINGS

FIG. 1 is a block diagram of a portion of a system in accordance with one embodiment of the present invention.

FIG. 2 is a flow diagram of a method in accordance with one embodiment of the present invention.

FIG. 3 is a block diagram of a serial branch predictor and its coupling to a memory in accordance with an embodiment of the present invention.

FIG. 4 is a block diagram of an entry of prediction information in a lower level of a memory hierarchy in accordance with an embodiment of the present invention.

FIG. 5 is a flow diagram of a method in accordance with one embodiment of the present invention.

FIG. 6 is a block diagram of a multiprocessor system in accordance with an embodiment of the present invention.

### DETAILED DESCRIPTION

In various embodiments, prediction information used in a branch predictor may be stored in multiple levels of a memory hierarchy. That is, the storage of prediction information may be split into multiple levels. In this way, improved performance may be realized as the branch predictor itself may be made relatively small to allow efficient operation, i.e., to provide predictions that keep up with execution of the processor pipeline. Additional prediction information that may provide good information for predictions can be stored in the memory hierarchy and then retrieved from lower levels of the memory hierarchy. For example, in one implementation prediction information may be stored in a cache level, e.g., a level 2 (L2) cache. This L2 cache may be a shared cache memory that includes instruction information as well as data information. At least a portion of this cache may be reserved for prediction information.

As will be described further below, various manners of obtaining prediction information from such an L2 cache for use in a branch predictor may be realized. Furthermore, to allow for even greater storage of branch prediction information, the prediction information stored in the L2 cache may be further stored out to even lower levels of a memory hierarchy, such as a system memory (e.g., a dynamic random access memory (DRAM)), and even out to a mass storage device such as a disk drive of a system. In this way, an essentially unlimited amount of prediction information may be stored and correspondingly, a significant improvement in prediction accuracy may be realized. By using non-volatile mass storage to store prediction information, such information associated with a particular program may be resiliently stored and returned to a branch predictor on a different run of the program, even after a power down event of a system.

By providing multiple levels of storage of prediction information, improved performance may be realized. Still further enhancements may be achieved by profiling a program to determine prediction information, and particularly prediction information that is appropriate for the program. For example, a profiling run of the program in a compiler may be performed to obtain a set of prediction data that is most likely to be used by the program (e.g., prediction data that focuses on hotspots and other portions of a program that are most frequently accessed).

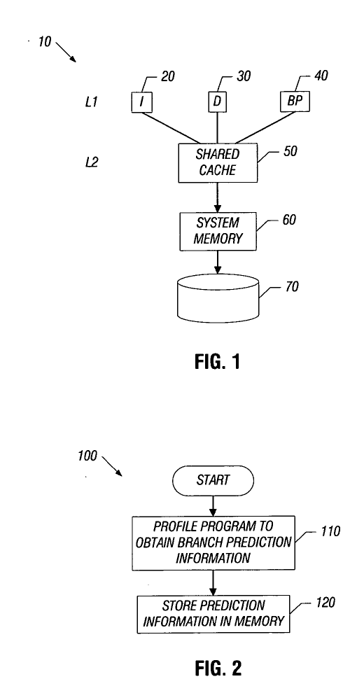

While various structures and manners of obtaining and storing extended profile information in accordance with an embodiment of the present invention may be realized, an example is described more fully herein for illustration. Referring now to FIG. 1, shown is a block diagram of a portion of a system in accordance with one embodiment of the present invention. As shown in FIG. 1, a system 10 includes various levels of a memory hierarchy. More particularly, a first level (i.e., a level 1 (L1)) may include an instruction cache 20, a data cache 30, and a branch prediction unit 40. In various embodiments, such L1 structures may be present in a processor, and may be implemented, e.g., as static random access memory (SRAM), along with various logic to enable access and control of these memory structures. Furthermore, while shown as separate structures in the embodiment of FIG. 1, it is to be understood that in some implementations a single SRAM may include all such L1 structures.

Still referring to FIG. 1, each of L1 structures 20, 30 and 40 may be coupled to a shared cache memory 50, which may be an L2 cache in some embodiments. Such an L2 cache may be also formed of SRAM and may be part of the processor, although situated further away from a processor pipeline than the level 1 structures. Furthermore, in many implementations shared cache memory 50 may be much larger than the level 1 structures. That is, the level 1 structures may be of relatively small size to aid in speed of access of the structures. In contrast, shared cache memory 50 of a second level may be much larger and accordingly may have relatively slower access time, although it enables storage of much more data without the need to go to further levels of a memory hierarchy.

Still referring to FIG. 1, shared cache memory 50 in turn may be coupled to a system memory 60, which may be a DRAM, in some embodiments. System memory 60 may include even greater storage capacities than shared cache memory 50, however such greater storage comes at the expense of slower access times, due to its further location from the processor along with the slower time to access DRAM as compared to SRAM. Finally, system memory 60 may be coupled to a mass storage device 70, which may be a disk drive of system 10. In various implementations, prediction information may be stored all the way out to mass storage device 70, enabling resilient storage of the information that may be accessed on different power ups of system 10.

Given the ability to store great amounts of profile information and provide such information to a branch predictor, it is also possible to provide mechanisms to make the most use of such storage. Accordingly, in some implementations profiling may be performed on a program to determine the prediction information, as well as to focus the prediction information on significant portions of a program execution (e.g., hotspots or other portions of frequent execution) and patterns most useful for branch prediction.

Referring now to FIG. 2, shown is a flow diagram of a method in accordance with one embodiment of the present invention. As shown in FIG. 2, method 100 may used to perform profiling. Specifically, a program of interest may be profiled to obtain branch prediction information (block 110). For example, a compiler may be used to profile the program to identify branch prediction information associated with conditional instructions of the program. Such information may then be stored in memory (block 120). In various embodiments, such memory may include one or more levels of a memory hierarchy. That is, such data is stored beyond the branch predictor itself, e.g., in an L2 cache, a system memory, and/or non-volatile storage such as a mass storage device. In this way, the branch prediction information can be accessed during normal execution of the program, and even on multiple program runs.

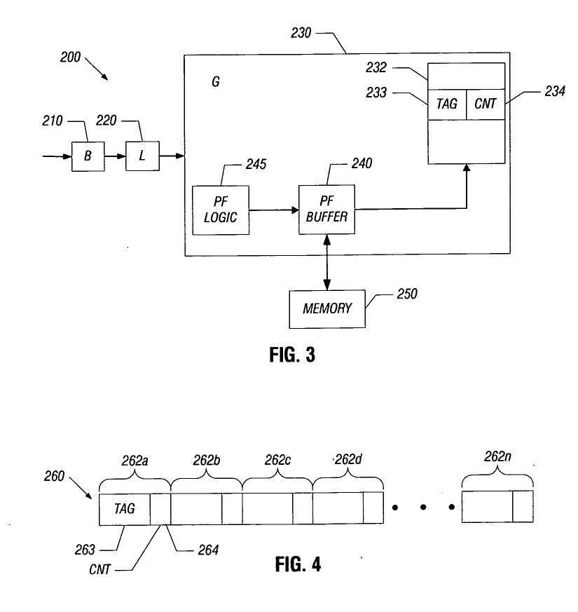

As described above, embodiments may be implemented in many different system types for use with various branch prediction structures. However for purposes of discussion, reference is made now to FIG. 3, which shows a block diagram of a serial branch predictor and its coupling to a memory in accordance with an embodiment of the present invention. The branch predictor may include a sequence of prediction stages, each using a different type of predictor. Each stage attempts to improve on the prediction coming from the prior stage. A stage may only change the previous stage's prediction when there is good reason to believe it can provide a more accurate prediction. Also, since the prior stage prediction is available, following stages can be designed to only capture new patterns not already handled by prior stages. This leads to an efficient implementation since the prior stage prediction is usually already accurate.

As shown in FIG. 3, branch predictor 200 may include a first level predictor 210, which may be a bimodal predictor. Such a bimodal predictor 210 may be coupled to receive an address, which may be a portion of an address of a branch instruction that is used to access an array, which may include a counter value, e.g., a multi-bit saturating up/down counter. The result of this access may be passed out of bimodal predictor 210 to a local predictor 220, which may be used to provide a prediction that corresponds to a value of a counter of a local predictor array that is indexed by certain bits of a branch address, as well as a pattern of directions recently taken by the branch.

Predictors may be improved by including profile data. In one embodiment, this data may be one bit for each branch in a program that indicates the direction the branch usually goes (i.e., bias). This bit can be set using a compiler by monitoring how the program behaves on typical inputs. This profile bit can be appended to a branch address when indexing counters, e.g., in bimodal predictor 210. This type of profiling improves the performance of bimodal predictor 210, especially with programs with a much larger number of branches than the number of bimodal counters available.

Still referring to FIG. 3, in turn the output decision of local predictor 220 may be provided to a global predictor 230. Such a global predictor may be used to track the recent history of all branch instruction outcomes to detect recurring patterns of program execution. Global predictor 230 may be a two-level predictor including global histories. Global predictor 230 may include an array 232 that includes entries each corresponding to a prediction indexed by a global value (i.e., for all branches). In some implementations, global predictor 230 may include a global register which outputs a value used in indexing array 232. More particularly each entry in array 232 includes a tag portion 233 and a counter portion 234. Tag portion 233 may correspond to a portion of the branch address that is used to index into array 232, while counter portion 234 corresponds to the branch prediction. Note that there is a tradeoff in determining an appropriate tag length. Longer tags mean a longer global history register (not shown in FIG. 3) and the ability to distinguish more global patterns. However, as the tag is lengthened, the number of tag values that will be contending for space in the predictor is also increased. Overly long tags will result in thrashing, where either a desired history value misses, or the tag will have been replaced very recently so that the associated counter will not have had sufficient time to train. For most benchmarks, a tag length of 6 bits may be suitable. Also, for reasonably sized predictors devoting half the predictor space (e.g., in the L1 structure) to global predictor 230, and a quarter of the space to each of bimodal predictor 210 and local predictor 220 works reasonably well. In various embodiments, an entry may be stored in array 232 only when an error occurs in a prior stage's prediction, i.e., the decision provided by local predictor 220 is in error. In this way, the size of array 232 may be reduced, improving speed and accuracy.

To improve performance by having prediction information available for many more addresses than available in array 232, global predictor 230 may be coupled to a memory hierarchy, namely a memory 250, e.g., an L2 cache. In this way, prediction information that is being evicted from global predictor 230 may be stored in memory 250.

Furthermore, when needed prediction information is not available in global predictor 230, such information may be obtained from memory 250 and stored in global predictor 230. While shown in the embodiment of FIG. 3 as being coupled only to global predictor 230, it is to be understood that the scope of the present invention is not so limited, and in other embodiments addition prediction levels may be coupled to memory 250. Furthermore, while described as being a level 2 cache, it is to be understood that in various embodiments memory 250 may correspond to any lower level memory. Furthermore, it is to be understood that memory 250 may be coupled to additional hierarchies of a memory, e.g., system memory and/or mass storage.

As further shown in FIG. 3, a prefetch logic 245 and a prefetch buffer 240 may be included in global predictor 230. As will be described further below, prefetch buffer 240 may be used to store prediction information prefetched from memory 250 under control of prefetch logic 245. In this way, unnecessary evictions from array 232 may be avoided.

The prediction data to be stored in lower levels of a memory hierarchy (e.g., an L2 cache and out to memory) can be thought of as an array indexed by a selection of bits from a branch address. This could be the low order bits of the branch, or the set index of the branch may be used. Indexing the data in lower levels of a memory hierarchy may be performed in different manners in various environments. However, for purposes of illustration an example is described. In an embodiment in which a cache line is 64 bytes wide, each cache line has 16 associated tag/counter pairs (6 and 2 bits each, or one byte for the pair), the table contains 1024*16 bytes, and the machine is byte addressed, indexing of the first byte of branch prediction information associated with the cache line (of 16 total) could be performed with the equivalent of the following C expression:
ByteTable[((branchAddress/64)&&1023)*16] [Eq. 1]
When implemented in hardware, all 16 bytes can be read at once as part of a single cache line access and provided to, e.g., prefetch buffer 240. While described with this particular implementation, the scope of the present invention is not limited in this regard.

Referring now to FIG. 4, shown is a block diagram of an entry of prediction information in a lower level of a memory hierarchy in accordance with an embodiment of the present invention. The lower level of the memory hierarchy may be in program space or may be a table in user memory, private system memory, or in another location. As shown in FIG. 4, entry 260 may correspond to a cache line, e.g., of an L2 cache such as memory 250. As shown in FIG. 4, cache line 260 may include multiple pairs 262a-262n (generically pair 262) of corresponding tag portions 263 and count portions 264 (only one of each is enumerated in FIG. 4). In various embodiments, tag portions 263 may correspond to 6 bits, although the scope of the present invention is not limited in this regard. Each pair 262 may correspond to an entry in array 232 of global predictor 230. In one embodiment, each cache line 260 may include 64 tag/counter pairs 262, although the scope of the present invention is not so limited.

Pairs 262 may be accessed in a direct mapped fashion within each entry. Bits from the global history value may be used to select a unique position within a given cache line 260. Since each history value has a unique position in the table for a particular branch, this can result a significant number of collisions between various history values. Accordingly, in some embodiments, pairs 262 may be fully associative within each entry and are replaced in least recently used (LRU) order. This approach results in far fewer collisions for a particular line size. For long lines, a set-associative approach may also be used to reduce the number of comparisons.

In some embodiments, branch bias profiling data (i.e, bias values) may be stored as an additional field in pairs 262. Note that while described with this particular implementation in the embodiment of FIG. 4, in other embodiments each entry may include only a few bits of a tag address, and the remaining portion of the tag address and counter value may be stored in a direct-mapped fashion. In this way, reduced cache consumption can be realized. Note that tags used by branch predictor 200 are partial. In other words, such tags do not encode all bits of a branch address (i.e., those not used in accessing the arrays).

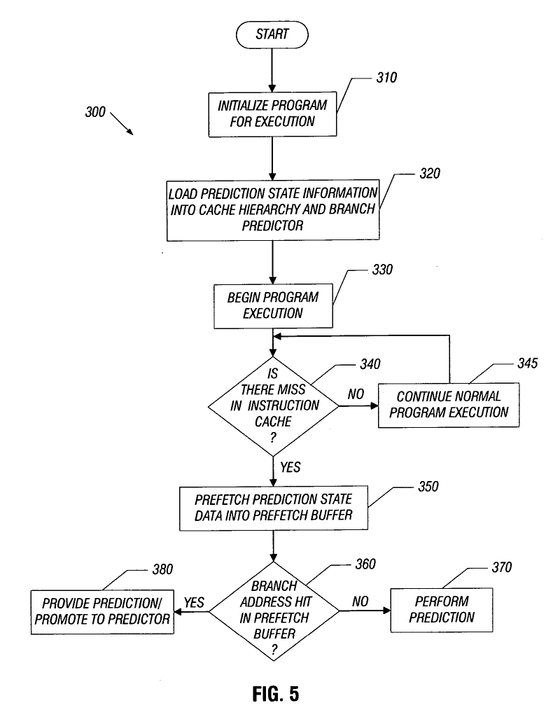

Referring now to FIG. 5, shown is a flow diagram of a method in accordance with one embodiment of the present invention. As shown in FIG. 5, method 300 may be used to execute a program using branch prediction information previously obtained. As shown in FIG. 5, method 300 may begin by initializing a program for execution (block 310). For example, an operating system (OS) may prepare a program for execution, e.g., by loading various data from memory into processor resources. Such information may include values for various control registers, data structures to be used by the program and the like. Furthermore, such initialization may further include initializing a branch predictor for operation with the program. Thus prediction state information may be loaded into a cache hierarchy and the branch predictor (block 320). For example, branch prediction information previously obtained, e.g., via profiling of the program or from previous runs of the program may be loaded from mass storage into a cache hierarchy (e.g., into a second level cache). Furthermore, at least portions of the prediction state information may be loaded into the branch predictor itself. For example, branch prediction information corresponding to a first portion of the program execution may be loaded from the L2 cache into the branch predictor structures. In one embodiment, global prediction data (e.g., pairs of tag and count values) may be loaded into an array of a global predictor. However, in other embodiments additional prediction information may be loaded into other levels of a branch predictor or other branch prediction structures. Accordingly, during normal execution when conditional instructions are encountered, branch address information may be provided to the branch predictor to perform predictions using the prediction data already present in the branch predictor. In this way, many prediction errors that occur when an uninitialized predictor warms up to a new program may be eliminated, as branch prediction information is already present in the branch predictor when beginning program execution.

When all preparation for execution of the program has completed, program execution may begin (block 330). Accordingly, instructions of the program may be provided to the processor for execution. Still referring to FIG. 5, next it may be determined whether there is a miss in an instruction cache (diamond 340). If no such miss occurs, normal program execution continues (block 345), and branch predictions may be made based on the data present in the branch predictor when conditional instructions are encountered. Thus, as shown in FIG. 5, control returns back to diamond 340. Note that a miss in a global predictor for prediction data corresponding to a given instruction may be due to insufficient space in the global predictor. Alternately, it may be a global pattern for which relying on the prior stage prediction is perfectly adequate and there is no need to perform additional predicting. For this reason, in some embodiments, a predictor takes no new action on a miss. Consequently, any information in the memory hierarchy that is to be used for predictions is first prefetched into the predictor in advance.

If instead at diamond 340 it is determined that there is a miss in an instruction cache, control may pass to block 350. Such an instruction miss implies that a new branch is about to be executed. Accordingly, prediction state data may be prefetched into a prefetch buffer (block 350). That is, branch data associated with the address for the new instruction may be obtained, e.g., from the L2 cache, and stored into a prefetch buffer of the global predictor. By storing such prefetch data into a prefetch buffer rather than directly into the array of the global predictor, unwanted evictions may be avoided. That is, it is possible that the prefetch data is less useful than the information present in the array of the predictor, and therefore should not replace such information.

Still referring to FIG. 5, next it may be determined whether a branch address hits in the prefetch buffer (diamond 360). If not, control passes to block 370, where a prediction may be performed based on data already present in the global predictor (block 370). If instead at diamond 360 it is determined that a branch address hits in the prefetch buffer, the prediction present at the hit location may be provided for program execution. Furthermore, the prediction information may be promoted to the global predictor, i.e., the array of the global predictor (block 380). In one embodiment, prefetches may be stored in the global predictor only if the local stage is wrong, and there is a global miss and the predetermined value helps. Of course, while described with this particular implementation in the embodiment of FIG. 5, it is to be understood that the scope of the present invention is not limited in this regard. Further, while not shown in the embodiment of FIG. 5, as L1 global counters are replaced, previously stored values may be propagated out to the next level of the memory hierarchy, e.g., an L2 cache. For example, when global stage information helps a prediction, the global values/counter pair may be written out to memory.

In another implementation, prefetch data is stored into an array of the global predictor only when there is a match to a global prediction register, the local prediction stage is wrong, and the prefetched tag data would otherwise miss in the global stage. Still further implementations are possible. For example, instead of performing prefetches on an instruction cache miss, in other embodiments various compiler strategies similar to instruction and data prefetching may be performed to drive such prediction information prefetching. Furthermore, in other implementations instead of prefetching into a prefetch buffer, prefetched prediction data may be directly stored into the array of the global predictor. In such an embodiment, a LRU replacement scheme may be used to control evictions from the array of the global and/or other predictors.

Accordingly, in various embodiments additional information stored in lower levels of a memory hierarchy enable prediction accuracies of a much larger predictor with the prediction speed of a smaller predictor. Furthermore, prediction data can be initialized before program runs, or saved across multiple runs, improving prediction accuracy from the start of program execution.

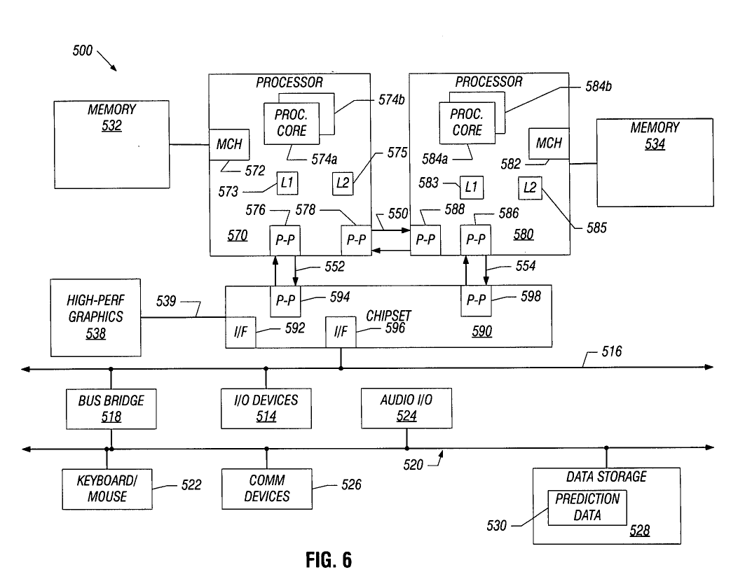

Embodiments may be implemented in many different system types. Referring now to FIG. 6, shown is a block diagram of a multiprocessor system in accordance with an embodiment of the present invention. As shown in FIG. 6, multiprocessor system 500 is a point-to-point interconnect system, and includes a first processor 570 and a second processor 580 coupled via a point-to-point interconnect 550. However, in other embodiments the multiprocessor system may be of another bus architecture, such as a multi-drop bus or another such implementation. As shown in FIG. 6, each of processors 570 and 580 may be multi-core processors including first and second processor cores (i.e., processor cores 574a and 574b and processor cores 584a and 584b) although other cores and potentially many more other cores may be present in particular embodiments. Each of processors 570 and 580 may further include various levels of a memory hierarchy, including a respective L1 cache 573 and 583 and an L2 cache 575 and 585, respectively.

In various implementations, L1 caches 573 and 583 may include predictor structures in accordance with an embodiment of the present invention. Furthermore, L2 caches 575 and 585 may be shared memory caches that provide for storage of instructions and data, as well as prediction information. Such prediction information may provide for maintenance of a significant amount of prediction information close to the predictor structures of L1 caches 573 and 583, while allowing these structures to maintain a relatively small size to enable predictions at a rate that keeps up with execution of instructions by the associated processor cores.

Still referring to FIG. 6, first processor 570 further includes a memory controller hub (MCH) 572 and point-to-point (P-P) interfaces 576 and 578. Similarly, second processor 580 includes a MCH 582 and P-P interfaces 586 and 588. As shown in FIG. 6, MCH's 572 and 582 couple the processors to respective memories, namely a memory 532 and a memory 534, which may be portions of main memory locally attached to the respective processors. Memories 532 and 534 may include a space for storage of even greater amounts of prediction data. That is, L2 caches 575 and 585 may be adapted to store subsets of prediction information stored in associated memories 532 and 534.

First processor 570 and second processor 580 may be coupled to a chipset 590 via P-P interconnects 552 and 554, respectively. As shown in FIG. 6, chipset 590 includes P-P interfaces 594 and 598. Furthermore, chipset 590 includes an interface 592 to couple chipset 590 with a high performance graphics engine 538. In one embodiment, an Advanced Graphics Port (AGP) bus 539 may be used to couple graphics engine 538 to chipset 590. AGP bus 539 may conform to the Accelerated Graphics Port Interface Specification, Revision 2.0, published May 4, 1998, by Intel Corporation, Santa Clara, Calif. Alternately, a point-to-point interconnect 539 may couple these components.

In turn, chipset 590 may be coupled to a first bus 516 via an interface 596. In one embodiment, first bus 516 may be a Peripheral Component Interconnect (PCI) bus, as defined by the PCI Local Bus Specification, Production Version, Revision 2.1, dated June 1995 or a bus such as the PCI Express bus or another third generation input/output (I/O) interconnect bus, although the scope of the present invention is not so limited.

As shown in FIG. 6, various I/O devices 514 may be coupled to first bus 516, along with a bus bridge 518 which couples first bus 516 to a second bus 520. In one embodiment, second bus 520 may be a low pin count (LPC) bus. Various devices may be coupled to second bus 520 including, for example, a keyboard/mouse 522, communication devices 526 and a data storage unit 528 such as a hard drive or other non-volatile storage which may include prediction data 530, which may be a resiliently-maintained database of prediction information for one or more programs executed on the multiprocessor system. In this way, prediction data obtained either via profiling or via run-time execution may be resiliently stored and accessed during program execution to enable improved prediction performance immediately upon beginning execution of the program. Further, an audio I/O 524 may be coupled to second bus 520.

Embodiments may be implemented in code and may be stored on a machine-readable storage medium having stored thereon instructions which can be used to program a system to perform the instructions. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
a prediction unit to predict a direction to be taken at a branch; and
a memory coupled to the prediction unit to store prediction data to be accessed by the prediction unit.

2. The apparatus of claim 1, wherein the memory comprises a cache memory, the cache memory comprising a shared memory for instructions and data.

3. The apparatus of claim 2, wherein the shared memory includes a plurality of entries to store the prediction data, wherein each of the plurality of entries includes pairs each including a tag and an associated count value.

4. The apparatus of claim 1, further comprising a dynamic random access memory (DRAM) coupled to the memory, the DRAM to store at least a portion of the prediction data; and
a mass storage device coupled to the DRAM, the mass storage device comprising a non-volatile memory to store at least the portion of the prediction data.

5. The apparatus of claim 4, further comprising a program loader to load state data of a program into the DRAM, the state data including the prediction data from the mass storage device, wherein the prediction data is associated with the program.

6. The apparatus of claim 2, wherein the prediction unit further comprises a buffer to store a portion of the prediction data in the cache memory, the portion of the prediction data to be prefetched into the buffer.

7. The apparatus of claim 6, further comprising first logic to prefetch the prefetched prediction data on an instruction cache miss.

8. A method comprising:
receiving prediction information associated with a program from a non-volatile storage of a memory hierarchy;
storing the prediction information in a cache memory of the memory hierarchy; and
loading a first portion of the prediction information into a prediction unit coupled to the cache memory.

9. The method of claim 8, further comprising loading a second portion of the prediction information into a buffer associated with the prediction unit based at least in part on an address of a conditional instruction of the program.

10. The method of claim 9, further comprising determining whether to insert the second portion into the prediction unit.

11. The method of claim 10, further comprising inserting the second portion into an array of the prediction unit if a previous stage of the prediction unit provides an erroneous prediction.

12. The method of claim 11, further comprising inserting the second portion into the array if a match to a global value occurs, and a tag value associated with the address of the conditional information is not present in the array.

13. The method of claim 12, further comprising inserting the second portion into the array if a local stage prediction is not correct.

14. The method of claim 9, further comprising loading the second portion into the buffer responsive to an instruction cache miss for the address of the conditional instruction.

15. The method of claim 8, further comprising initializing the program for execution, wherein the initializing includes storing the prediction information in the cache memory.

16. The method of claim 8, further comprising indexing into the cache memory using at least a portion of an address of a conditional instruction of the program.

17. An article comprising a machine-readable storage medium including instructions that if executed by a machine enable the machine to perform a method comprising:
profiling a program to obtain prediction information for conditional instructions in the program; and
storing the prediction information in a storage coupled to a branch predictor.

18. The article of claim 17, wherein storing the prediction information comprises storing the prediction information in a shared cache memory coupled to the branch predictor.

19. The article of claim 18, wherein the method further comprises writing the prediction information from the shared cache memory to a non-volatile mass storage device.

20. The article of claim 19, wherein the method further comprises loading the prediction information from the non-volatile mass storage device to the shared cache memory.

21. The article of claim 17, wherein the method further comprises prefetching a portion of the prediction information from the storage into a buffer associated with the branch predictor.

22. The article of claim 21, further comprising prefetching the portion based upon an instruction cache miss.

23. The article of claim 17, wherein the method further comprises evicting prediction information from the branch predictor to the storage.

24. A system comprising:
a predictor to predict results of conditional instructions;
a first memory coupled to the predictor, the first memory to store at least a first subset of prediction data usable by the predictor to predict the results; and
a dynamic random access memory (DRAM) coupled to the first memory.

25. The system of claim 24, further comprising a mass storage device coupled to the DRAM to resiliently store the prediction data.

26. The system of claim 24, wherein the DRAM is to store at least the first subset of the prediction data.

27. The system of claim 24, wherein the predictor comprises a serial predictor including a final stage having an array to store a portion of the first subset of the prediction data.

28. The system of claim 27, wherein the final stage further comprises a buffer coupled to the array, the buffer to store prefetched prediction data obtained from the first memory.

29. The system of claim 24, wherein the first memory comprises a shared memory to store data, the first memory further to store a plurality of entries each including pairs of tag values and count values.

30. The system of claim 24, further comprising a processor including the predictor.
